(19) United States
(12) Patent Application Publication
(10) Pub. No.: US 2003/0015851 A1
(43) Pub. Date: Jan. 23, 2003

(54) Combination toolbox, workbench, dispensing crib and stool

(76) Inventor: Richard D.W. Hahn, Diamond Bar, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/909,203

(22) Filed: Jul. 18, 2001

(51) Int. Cl. B62B 7/02

(52) U.S. Cl. 280/47.24; 280/47.17

(57) ABSTRACT

A portable toolbox has a top, bottom, front and rear panels forming a box structure with opposing sides tilted off-vertical so as to converge upwardly. A plurality of hinged drawers and fixed bins are arranged on each side of the toolbox. The rear panel terminates at a pair of supporting feet for resting the apparatus on a supporting surface. The top panel provides an upwardly facing work surface with a pair of hand holes separated by a hand grip for carrying the apparatus. A forward and a rearward sliding retractable work surface extender frames are positionable between a retracted position, secured within the box structure and an extended position directed outwardly from the box structure for resting a workpiece.

### BACKGROUND OF THE INVENTION

1. Field of the Invention

This invention relates generally to tool boxes and work benches and more particularly to a portable toolbox that functions as a work bench and stool.

2. Description of Related Art

The following art defines the present state of this field:

Gale, U.S. D252,197 describes a combined tool cart and work table design.

Jordon, U.S. Pat. No. 3,118,685 describes a portable combination tool chest and work bench, including: two laterally spaced side walls having transversely aligned, elongate openings formed in the lower portions thereof, said side walls each having a straight upper edge, a rear edge, a lower edge shorter than said upper edge and parallel thereto, a forward edge shorter than said rear edge and parallel thereto, and an upwardly and forwardly inclined edge that extends upwardly from the forward end of said lower edge to effect a junction with the lower end of said forward edge; rear and forward end pieces that extend transversely between said side walls; a first rigid sheet parallel to said upper edges and disposed within the confines of said side walls and end pieces and affixed to the interior surfaces thereof above said openings, which first sheet, end pieces and side walls cooperatively define a tool chest; a second rigid sheet parallel to said first sheet and spaced below said openings, said second sheet being situated within the confines of said side walls and rear end piece affixed to the interior surfaces thereof, which second sheet services as a temporary support for tools when not in said chest; a rigid rectangular cover which is longer than said side walls and sufficiently wide to extend between the exterior surfaces of said side walls when resting on said upper edges thereof and the upper edges of said rear and forward end pieces said cover having end portions that overhang said rear and forward end pieces; hinge means pivotally connecting one longitudinal edge of said cover to one of said side walls to permit said cover to be pivoted into a position where access may be had to said chest and for holding said cover in a fixed longitudinal and transverse position relative to said side walls and end walls whereby said cover, said walls and end pieces cooperatively provide said work bench; means for locking said cover in a position to close said chest when said end pieces; two laterally separated wheels; means for locking said cover in a position to close said chest when said cover rests on said upper edges of said side walls and said end pieces; two laterally separated wheels; means for rotatably supporting said wheels from said side walls adjacent said upwardly and forwardly inclined edges thereof; handle means extending rearwardly from said rear end piece for moving said cover, side walls and end pieces as an integral unit on said wheels to a desired location; and leg means extending downwardly from the rearward portion of said second sheet for disposing said cover in a horizontal plane when said cover rests on said upper edges to permit said cover to be used for a work bench surface, which cover, side walls, end pieces and first and second sheets are capable of occupying upwardly and rearwardly extending positions when said junctions contact the same surface on which said wheels rest.

Helms, U.S. Pat. No. 4,350,366 describes a manually propelled lawn and garden cart comprising of a bottom storage box and an open frame securely fastened to the top of the bottom storage box, means to support lawn and garden tools in the open frame and the bottom storage box, preferably by tubes fastened between holes in a cross piece at the top of the open frame, and a similar cross piece which is the top of the bottom storage box. Wings are pivotably attached between extensions to the bottom storage box and the open frame. The wings have brackets attached to them which receive a trash bag bracket pivotably attached to the open frame near its top so as to hold the lawn and garden cart in a stable position. An adjustable leg is attached to the bottom of each wing which may be adjusted so as to touch the ground when the lawn and garden cart is placed in a horizontal position so that the adjustable legs, together with wheels attached to the bottom storage box, form a 4 point support. A back box attached to the open frame has side brackets attached to it to receive pivots attached to a handle. The lawn and garden cart may be stored in a very small space in an upright position by closing the wings, adjusting the adjustable legs and placing the handle in an upright position.

LeBrun, U.S. Pat. No. 5,148,917 describes a multiple tool organizing and storing carrier including a central housing, a pair of opposite side doors, a lid and a plurality of tool holders. The central housing has a bottom wall and upright opposite end walls and an upright partition extending between the opposite end walls. The side doors are pivotally mounted along lower edges thereof to opposite edges of the bottom wall of the central housing. The side doors are pivotable between opened positions away from the central housing and closed positions engaged with opposite side edges of the end walls of the central housing. The lid is hinged to an upper edge of one of the side doors and is pivotally movable for opening away from and closing upon an open top formed by the end walls of the central housing and the side doors when in their closed positions. The tool holders are separately supported on opposite sides of the partition and on the interiors of the side doors.

Blohm, U.S. Pat. No. 5,224,531 describes a portable apparatus for storing tools in an organized fashion and which also converts to a combination saw table, router table and workbench. The apparatus can be readily maneuvered, loaded into a truck bed and stored when folded. It also provides a rigid work surface with easy tool access when in the set-up position.

Goring, U.S. Pat. No. 5,338,049 describes a saddle and equipment cart which consists of a main cabinet body having an open top with a storage compartment for storing various equestrian articles therein. A pair of spaced apart ground wheels are pivotally attached to a lower back end of the main cabinet body, for supporting the cart above the ground. A handle is attached to an upper front end of the main cabinet body for manual operation of the cart. A pair of spaced apart support legs are attached to a lower front end of the main cabinet body in a downward position, to cooperate with the ground wheels in supporting the cart on the ground. A lid is hinged to one side at the open top of the main cabinet body. A saddle bearer on the lid has a dorsal fin to receive and hold an equestrian saddle thereon. A boot valet being a pair of L-shaped rods are mounted to the back end of the main cabinet body, with each rod having a knob to retain each of a pair of riding boots in an inverted position thereon.

Parks, U.S. Pat. No. 5,893,572 describes a portable workstation including a storage structure and an integrated dolly. The storage structure resembles a generally-upright cabinet having a top platform with upward-folding expansion leaves. The storage structure is defined by a pair of vertical side walls spaced apart by a back wall. One fixed shelf and two folding shelves extend between the side walls. The shelves are useable as steps, but are securable in alternate, bin-forming positions. A box-storage chamber and flexible straps provide storage locations for tools. A wheeled dolly is attached to the storage structure by a pair of slide pins.

Tisbo et al., U.S. Pat. No. 6,086,073 describes a portable work center includeing a molded base panel having a plurality of clamping members, at least one wheel assembly support and at least one support leg in spaced relation to the wheel assembly support. A molded top panel is in spaced, parallel relation to the base panel, and has a plurality of clamping members, each corresponding to a clamping member on the base panel. A pair of opposingly oriented side panels extend between and connect the top and base panels to one another. A rear panel is positioned adjacent and between the side panels and extends between the top and base panels. A pair of pivotal front door panels is disposed in opposing relation to the rear panel and extends substantially between the top and base panels and the side panels. Together, the side panels, rear panel, top panel, base panel and door panels define an internal storage region and four corners. Corner support posts are positioned at each of the corners and extend between the base panel and the top panel. The posts traverse through and join the respective side panels with the rear panel and join the respective side panels with the front door panels. The posts positioned at the front corners are pintles defining axes for pivoting the front door panels relative to the side panels. Clamping member secure the posts to the top and base panels, and a wheel assembly is operably connected to the base at the wheel assembly support.

The prior art teaches the use of portable combination workbenches and toolboxes, but does not teach such an apparatus with stable footing when at rest and mobile footing when raised for being pulled-along. The prior art also does not teach such a combination with tool and hardware storage facility tilted laterally for improved item security when being moved. The present invention fulfills these needs and provides further related advantages as described in the following summary.

### SUMMARY OF THE INVENTION

The present invention teaches certain benefits in construction and use which give rise to the objectives described below.

The portable toolbox has a top, bottom, front and rear panels forming a box structure with opposing sides tilted off-vertical so as to converge upwardly. A plurality of hinged drawers and fixed bins are arranged on each side of the toolbox. The rear panel terminates at a pair of supporting feet for resting the apparatus on a supporting surface. The top panel provides an upwardly facing work surface with a pair of hand holes separated by a hand grip for carrying the apparatus. A forward and a rearward sliding retractable work surface extender frames are positionable between a retracted position, secured within the box structure and an extended position directed outwardly from the box structure for resting a workpiece.

A primary objective of the present invention is to provide an apparatus and method of use of such apparatus that provides advantages not taught by the prior art.

Another objective is to provide such an invention capable of storing a relatively large number of tools and hardware items and of dispensing these items in a convenient manner.

A further objective is to provide such an invention capable of both closed drawer storage and open bin storage in a manner wherein items stored therein are prevented from falling out of the drawers and bins when the invention is subject to vibration.

A still further objective is to provide such an invention capable of functioning as a storage facility, workbench, dispensing crib, step stool, and support for sitting.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIGS. 1 and 2 are perspective views of the preferred embodiment of the invention;

FIGS. 3 and 4 are partial side elevational views thereof; and

FIGS. 5 and 6 are partial side elevational views thereof showing a rear portion with extendable elements of the invention withdrawn and extended respectively.

### DETAILED DESCRIPTION OF THE INVENTION

The above described drawing figures illustrate the invention in at least one of its preferred embodiments, which is further defined in detail in the following description.

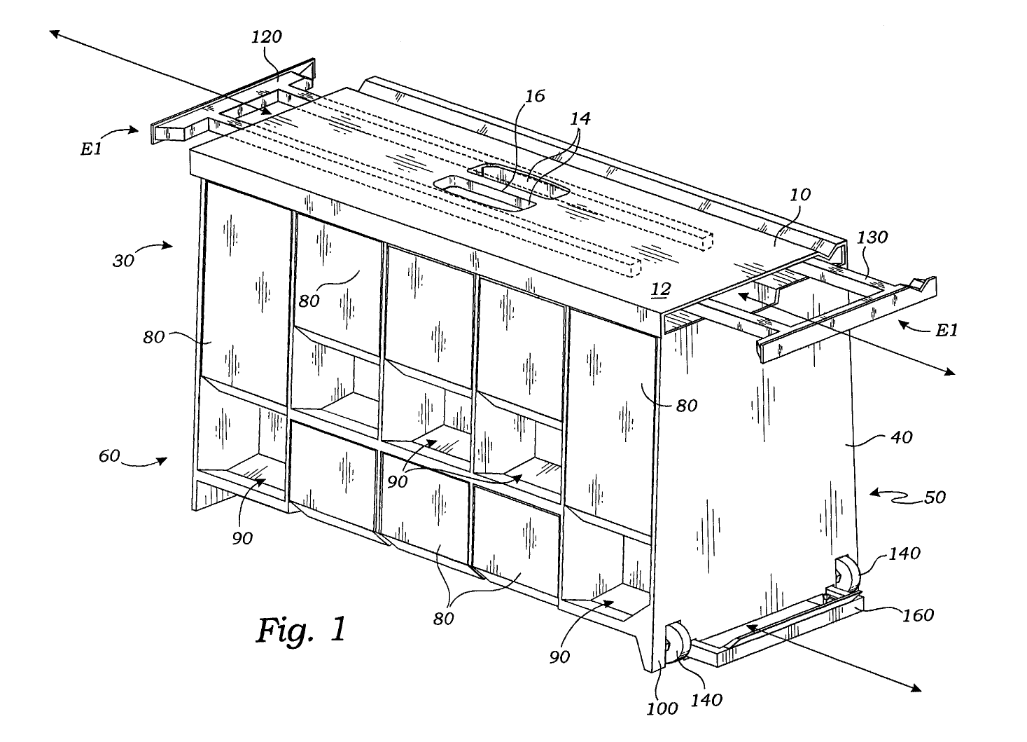

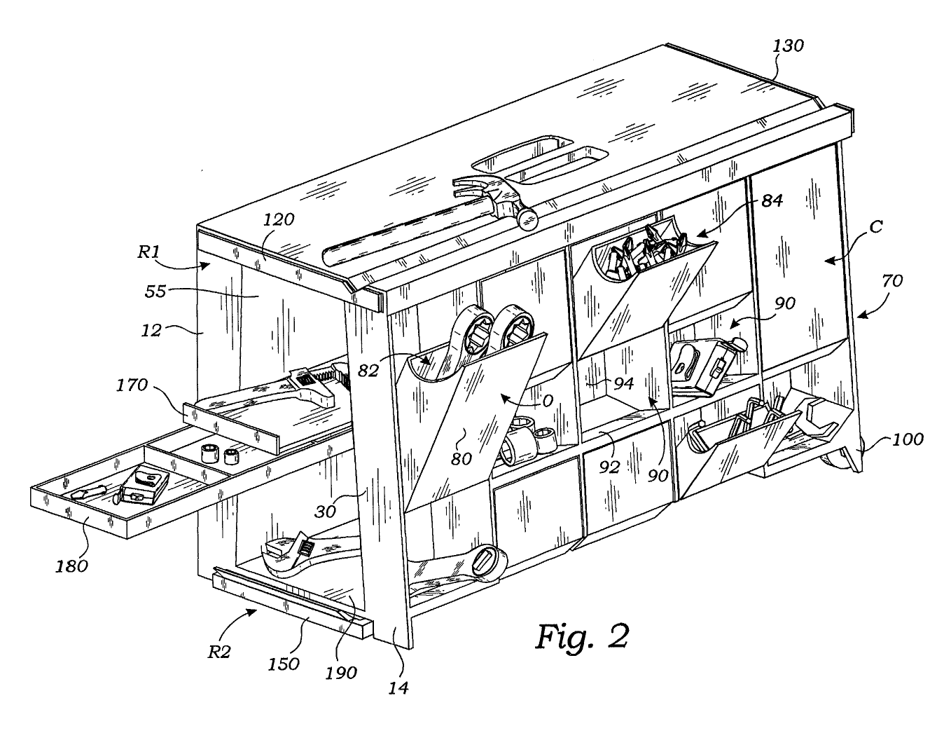

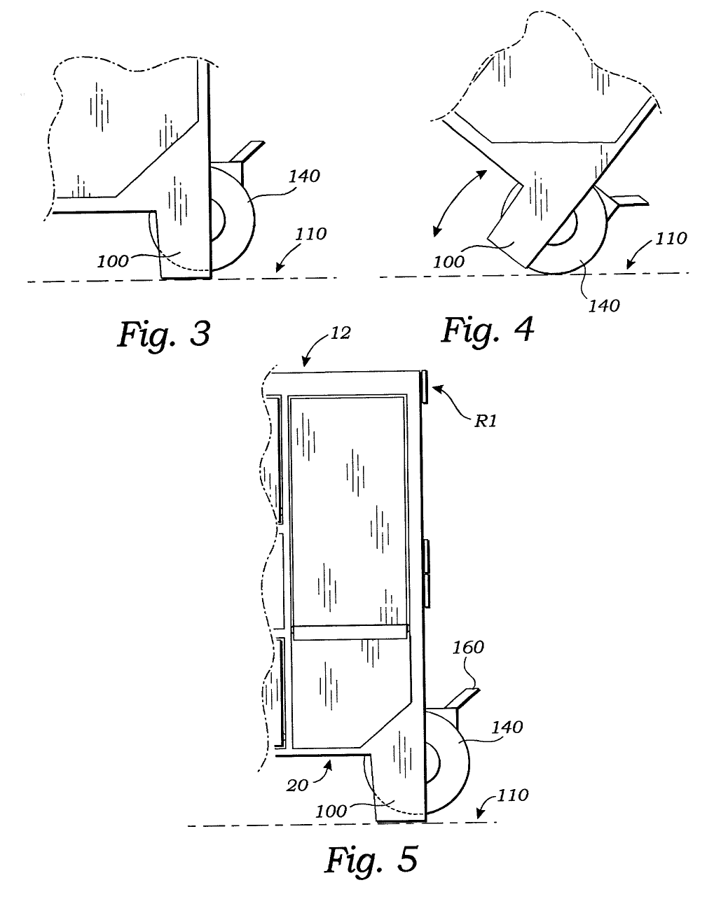

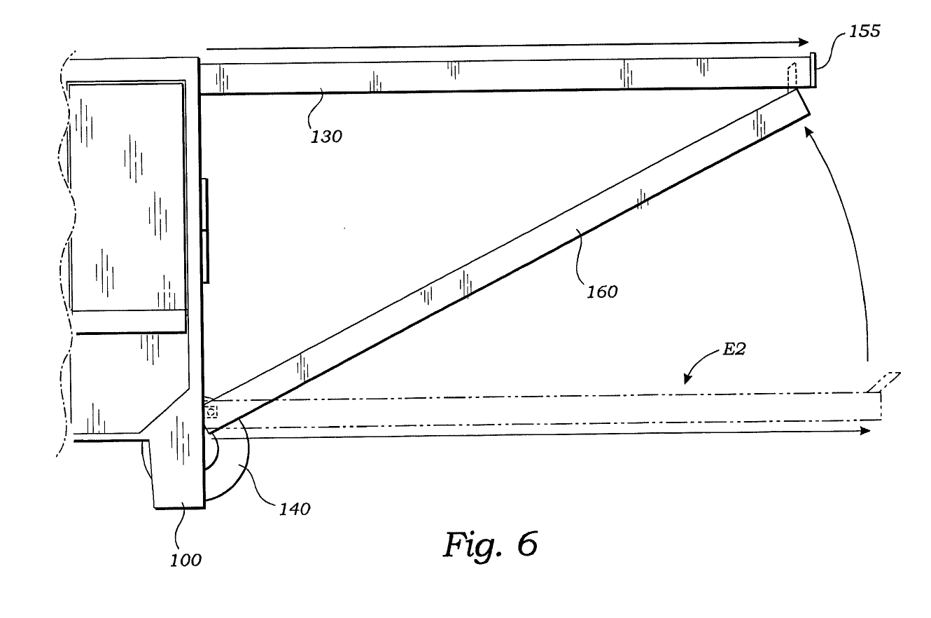

The present invention is a portable toolbox apparatus with several other key functions which will be described below. A top 10, bottom 20, front 30 and rear 40 panels form a box structure 50 with opposing sides 60, 70 tilted off-vertical to mutual converge upwardly. A plurality of hinged drawers 80 and fixed bins 90 are arranged on each of the opposing sides 60, 70. These drawers 80 and bins 90, being accessible from the outside of the apparatus function as a parts and tool crib to make the availability of items needed in working more convenient. The tilt of the sides provides for maintaining closure of the draws 80 and movement of items to the rear of the drawers and bins to prevent loss. The rear panel 40 terminates downwardly at a pair of supporting feet 100 which are positioned for resting the apparatus in contact with a supporting surface 110. The top panel 10 provides an upwardly facing work surface 12 defining a pair of hand holes 14 separated by a hand grip 16 for carrying the portable toolbox. This surface 12, may be used to sit upon when working, to stand upon for reaching and for placing a workpiece (not shown) upon when working. A forward 120 and a rearward 130 sliding retractable work surface extender frames, are each linearly positionable between a retracted position “R1” secured within the box structure 50, as shown in FIGS. 2 and 5, and an extended position “E1” directed and positioned outwardly from the box structure 50, as shown in FIGS. 1 and 6, where partial and full extension is depicted.

Preferably, a pair of spaced apart rotating wheels 140 are mounted, as shown in FIG. 1, adjacent to the supporting feet 100, the wheels positioned above the supporting surface 110 when the work surface 12 is horizontal, as shown in FIG. 5 where the apparatus rests on the supporting feet 100 at the rear of the apparatus, and on the front panel 30 at the front of the apparatus. However, the wheels 140 contact the supporting surface 110 for supporting the apparatus in rolling motion, when the forward extender frame 120 is lifted as a handle for pulling the apparatus, and this is shown in FIG. 4 where the wheels 140 rather than the feet 100 contact the supporting surface 110.

A forward 150 and a rearward 160 extender frame braces engage the box structure 50 and are enabled for linear positioning between a retracted position “R2” fully secured within the box structure 50, as shown in FIG. 2, and an extended position “E2” directed outwardly from the box structure 50, as shown in FIG. 1 (partially extended) and FIG. 6 (fully extended). the extender frame braces 150, 160 are each enabled for upward pivoting and engaging of a terminal end 155 of one of the extender frames for providing rigidizing support as the extender frames 120, 130 are designed to receive loads in supporting work pieces.

Each one of the hinged drawers 80 comprises an open top pocket structure 82 providing an interior drawer volume 84. Each hinged drawer 80 is movable between a closed attitude “C” wherein the interior drawer volume 84 is inaccessible and an open, laterally outwardly tilted, attitude “O” providing access to the interior drawer volume 84 for placement and removal of tools and hardware. Preferably, each one of the fixed bins 90 provides a bottom bin surface 92 angled for urging hardware toward a rear wall 94 of the fixed bin 90.

The front panel 30 comprises a left 12 and a right 14 front panel portions, where the front panel portions are spaced apart (FIG. 2) providing access to an interior box volume 55. At least one sliding shelf 170 is mounted on side strips within the volume 55, for enabling movement thereof between a retracted shelf position fully enclosed within the interior box volume 55, and an extended shelf position partially extending forward of the front panel 30 for providing access to tools and parts placed on it. Further, an interior drawer 180 may be similarly mounted for sliding access as further shown in FIG. 2. An interior bottom surface 190 is provided for storing heavy items and raw materials.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A portable toolbox apparatus comprising: a top, bottom, front and rear panels forming a box structure with opposing sides tilted off-vertical for mutual upward convergence; a plurality of hinged drawers and fixed bins arranged on each of the opposing sides; the rear panel terminating downwardly with a pair of supporting feet positioned for resting the apparatus in contact with a supporting surface; the top panel providing an upwardly facing work surface defining a pair of hand holes separated by a hand grip for carrying the apparatus; a forward and a rearward sliding retractable work surface extender frames, each linearly positionable between a retracted position secured within the box structure and an extended position directed outwardly from the box structure.

2. The apparatus of claim 1 further comprising a pair of spaced apart rotating wheels adjacent to the supporting feet, the wheels positioned above the supporting surface when the work surface is horizontal, the apparatus resting on the supporting feet; the wheels contacting the supporting surface for supporting the apparatus in rolling motion when the forward extender frame is lifted as a handle for pulling the apparatus.

3. The apparatus of claim 1 further comprising a forward and a rearward extender frame braces engaged with the box structure and enabled for linear positioning between a retracted position fully secured within the box structure and an extended position directed outwardly from the box structure, the extender frame braces each enabled for upward pivoting and engaging of a terminal end of one of the extender frames in rigidizing support thereof.

4. The apparatus of claim 1 wherein each one of the hinged drawers comprises an open top pocket structure providing an interior drawer volume, the hinged drawer movable between a closed attitude wherein the interior drawer volume is inaccessible and an open, laterally outwardly tilted, attitude providing access to the interior drawer volume for placement removal of tools and hardware in and from the hinged drawer.

5. The apparatus of claim 1 wherein each one of the fixed bins provides a bottom bin surface angled for urging hardware toward a rear wall of the fixed bin.

6. The apparatus of claim 1 wherein the front panel comprises a left and a right front panel portions, the front panel portions spaced apart providing access to an interior box volume.

7. The apparatus of claim 6 further comprising at least one sliding shelf mounted for enabling movement thereof between a retracted shelf position fully enclosed within the interior box volume, and an extended shelf position partially extending forward of the front panel.
